(19) United States
(12) Patent Application Publication
(10) Pub. No.: US 2025/0117414 A1
(43) Pub. Date: Apr. 10, 2025

(54) LAYERED DATABASE QUERIES FOR CONTEXT INJECTION FOR TECHNICAL SUPPORT

(71) Applicant: Insight Direct USA, Inc., Chandler, AZ (US)

(72) Inventors: David McCurdy, Centennial, CO (US); Jason Rader, Jacksonville, FL (US)

(21) Appl. No.: 18/911,854

(22) Filed: Oct. 10, 2024

Related U.S. Application Data
(60) Provisional application No. 63/543,460, filed on Oct. 10, 2023.

(51) Int. Cl. G06F 16/332; G06F 16/33

(52) U.S. Cl. CPC G06F 16/3329; G06F 16/3347

(57) ABSTRACT

A method of automated technical support includes receiving a natural-language prompt from a user and a user identifier corresponding to the user, the natural-language prompt including at least one technical support query, querying a first database with the user identifier to retrieve first information, generating a vector embedding representative of the first information and the natural-language prompt, querying a second database using the vector embedding to retrieve second information, and generating a natural-language response text based on the natural-language prompt, the first information, and the second information. The second database is a vector database comprising a plurality of vectors, each vector of the plurality of vectors representative of a text segment of a plurality of text segments, the second information comprises at least one text segment of the plurality of text segments, and the natural-language response text responsive to the at least one technical support query.

### CROSS-REFERENCE TO RELATED APPLICATION

This application is a nonprovisional application claiming the benefit of U.S. provisional Ser. No. 63/543,460, filed on Oct. 10, 2023, entitled “LAYERED DATABASE QUERIES FOR CONTEXT INJECTION FOR TECHNICAL SUPPORT” by D. McCurdy and J. Rader.

### FIELD OF THE INVENTION

The present disclosure relates to context injection for generative language models and, more particularly, systems and methods for layered database queries for context retrieval.

### BACKGROUND

Generative artificial intelligence (AI) language models, such as large language models and/or transformer models, are capable of dynamically generating content based on user prompts. Some language models are capable of generating human-like text and can be incorporated into text chat programs in order to mimic the experience of interacting with a human in a text chat.

Human-generated prompts can be augmented with additional information to provide context to the language model and improve the accuracy and/or relevance of natural-language generated by the model in response to a prompt.

### SUMMARY

An example of a method of automated technical support includes receiving a first natural-language prompt from a user and a user identifier corresponding to the user, the first natural-language prompt including at least one technical support query, querying a first database with the user identifier to retrieve first information, generating a first vector embedding representative of the first information and the first natural-language prompt, querying a second database using the first vector embedding to retrieve second information, and generating a first natural-language response text based on the first natural-language prompt, the first information, and the second information. The second database is a vector database comprising a plurality of vectors, each vector of the plurality of vectors representative of a text segment of a plurality of text segments, the second information comprises at least one text segment of the plurality of text segments, and the first natural-language response text responsive to the at least one technical support query.

An example of a system includes a first database configured to store first user-specific information, a second database configured to store a plurality of vector embeddings representative of a plurality of natural-language text segments, and a network-connected device in electronic communication with the first database and with the second database. Each first vector embedding of the plurality of vector embeddings is representative of one natural-language text segment of the plurality of natural-language text segments. The network-connected device includes a processor and at least one memory encoded with instructions that, when executed, cause the processor to receive a natural-language prompt from a user and a user identifier corresponding to the user, query the first database with the user identifier to retrieve first information, generate a vector embedding representative of the first information and the natural-language prompt, query the second database using the vector embedding to retrieve second information, and generate, using a language model executed by the processor, a natural-language response text responsive to the user query based on the natural-language prompt, the first information, and the second information. The first natural-language prompt includes at least one technical support query and the first natural-language response text responsive to the at least one technical support query.

A further example of a method of automated technical support includes receiving a first natural-language prompt from a user and a user identifier corresponding to the user, a first database with the user identifier to retrieve first information, generating a representation of the first information and the first natural-language prompt, querying a second database using the first representation to retrieve second information, and generating, by a language model, a first natural-language response text based on the first natural-language prompt, the first information, and the second information. The first natural-language prompt includes at least one technical support query and the first natural-language response text is responsive to the at least one technical support query.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is a schematic diagram of an example of a system for providing technical support using layered database queries.

FIG. 2 is a flow diagram of an example of a method of providing technical support using layered database queries.

FIG. 3 is a flow diagram of an example of a method creating database vectors based on a user's chat history.

While the above-identified figures set forth one or more examples of the present disclosure, other examples are also contemplated, as noted in the discussion. In all cases, this disclosure presents the invention by way of representation and not limitation. It should be understood that numerous other modifications and examples can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

The present disclosure relates to systems and methods for automated natural-language generation for technical support using sequential, layered database queries for context injection. The sequential, layered database query approaches disclosed herein reduce language model hallucinations and/or fabrications and, further, improve accuracy and relevance of machine-generated natural language (i.e., by a machine-learning model) to a user's technical problem, increasing the likelihood that machine-generated natural language can be used to resolve user technical queries. As will be explained in more detail subsequently, the systems and methods disclosed herein use enable the injection of user-specific information into a user-supplied prompt for querying a vector database. The information retrieved from the vector database and the user-specific information can then be used to supplement the original user prompt prior to natural-language text generation by the language model. The systems and methods disclosed herein significantly improve the relevance of vector database queries to an individual user and, accordingly, can be used to reduce the quantity of text provided to a language model as context while providing similar or superior improvements to hallucination/fabrication reduction as systems and methods using significantly more text information as context for natural-language text generation. Advantageously, reducing the quantity of text used as input to a language model can provide concomitant reductions to processing power and time required to generate a natural-language output.

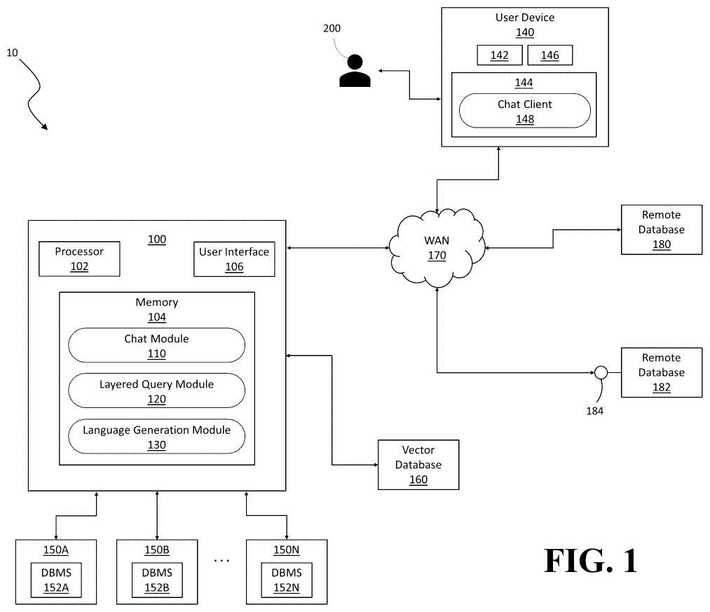

FIG. 1 is a schematic depiction of technical support system 10, which is a system for providing context to user prompts for a language model using layered database queries. Technical support system 10 includes server 100, user device 140, databases 150A-N, vector database 160, wide area network (WAN) 170, remote database 180, remote database 182, and application programming interface (API) 184. Server 100 includes processor 102, memory 104, and user interface 106. Memory 104 stores chat module 110, layered query module 120, and language generation module 130. User device 140 includes processor 142, memory 144, and user interface 146. Memory 144 stores chat client 148. Databases 150A-N organize data using database management systems (DBMSs) 152A-N, respectively. FIG. 1 also depicts user 200. As will be explained in more detail subsequently, technical support system 10 uses a layered query approach to incorporate retrieve contextual information that can be used to augment user prompts provided to a language model, reducing fabrications (e.g., AI hallucinations) created by the language model and also increasing both the accuracy of responses generated by the language model as well as the value of those responses for users. Advantageously, as compared to existing systems capable of automated technical support, technical support system 10 increases the likelihood that a response to a user-generated technical query generated by a machine-learning language model is relevant to and/or is able to resolve the user technical query. The layered query approach detailed herein uses successive database queries to retrieve information from multiple databases. More specifically, the layered query approach detailed herein incorporates information retrieved from one or more initial queries of structured and/or semi-structured databases to augment subsequent queries made to one or more vector databases. Some or all retrieved information (i.e., data retrieved from structured/semi-structured and/or vector databases) can be incorporated into the initial user prompt to provide context to a language model that generates responses for natural-language chat applications.

Server 100 is a network-connected device that is connected to WAN 170 as well as user device 140, databases 150A-N, and vector database 160. Server 100 also includes or more hardware elements, devices, etc. for facilitating electronic communication with WAN 170, databases 150A-N, user device 140, a local network, and/or any other suitable device via one or more wired and/or wireless connections. Although server 100 is generally referred to herein as a server, server 100 can be any suitable network-connectable computing device for performing the functions of server 100 detailed herein. Server 100 is configured to operate technical support chat service accessible to users via WAN 170. In particular, server 100 is configured to perform automated technical support of user technical issues, and is able to generate natural-language responsive to user technical issues. As used herein, “automated technical support” or “automated support” refers to technical support provided to a user using one or more automated natural-language messages generated by server 100 or another suitable computing device. Conversely, as used herein, “human-mediated technical support” or “human-mediated support” refers to technical support provided to a user by a human technical support technician.

While server 100 is generally discussed herein with reference to automated technical support, server 100 can also confer benefits to hybrid technical support strategies that incorporate both automated and human-mediated support. For example, it may be advantageous to use an automated technical support approach initially in response to a user technical query, and to subsequently transition (e.g., after a certain number of messages without resolving the user technical issue) to a human-mediated support approach. Advantageously, such a hybrid technical support scheme can reduce the human labor required to provide technical support by using automatedly-generated natural-language responses to resolve at least a portion of user technical problems.

Processor 102 can execute software, applications, and/or programs stored on memory 104. Examples of processor 102 can include one or more of a processor, a microprocessor, a controller, a digital signal processor (DSP), an application specific integrated circuit (ASIC), a field-programmable gate array (FPGA), or other equivalent discrete or integrated logic circuitry. Processor 102 can be entirely or partially mounted on one or more circuit boards.

Memory 104 is configured to store information and, in some examples, can be described as a computer-readable storage medium. Memory 104, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 104 is a temporary memory. As used herein, a temporary memory refers to a memory having a primary purpose that is not long-term storage. Memory 104, in some examples, is described as volatile memory. As used herein, a volatile memory refers to a memory that that the memory does not maintain stored contents when power to the memory 104 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on server 100 (e.g., by a computer-implemented machine-learning model or a data processing module) to temporarily store information during program execution.

Memory 104, in some examples, also includes one or more computer-readable storage media. Memory 104 can be configured to store larger amounts of information than volatile memory. Memory 104 can further be configured for long-term storage of information. In some examples, memory 104 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories.

User interface 106 is an input and/or output device and/or software interface, and enables an operator, such as user 200, to control operation of and/or interact with software elements of server 100. For example, user interface 106 can be configured to receive inputs from an operator and/or provide outputs. User interface 106 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, or other type of device for facilitating input and/or output of information in a form understandable to users and/or machines.

As will be described in more detail subsequently, server 100 generates natural-language text responses based on user-provided natural-language prompts. In at least some examples, server 100 can generate natural-language text responses for a chat service, such that the user-provided prompts and natural-language text responses generated by server 100 mimic a conversation between two humans. Users can access chat functionality of server 100 by directly accessing server 100 (e.g., by user interface 106) and/or by accessing the functionality of server 100 through another device, such as user device 140.

User device 140 is a user-accessible electronic device that is directly connected to server 100 and/or is connected to server 100 via a local network. User device 140 includes processor 142, memory 144, and user interface 146, which are substantially similar to processor 102, memory 104, and user interface 106, respectively, and the discussion herein of processor 102, memory 104, and user interface 106 is applicable to processor 142, memory 144, and user interface 146, respectively. User device 140 can be, for example, a personal computer or any other suitable electronic device for performing the functions of user device 140 detailed herein. Memory 144 stores software elements of chat client 148, which will be discussed in more detail subsequently and particularly with respect to the function of chat module 110 of server 100.

Databases 150A-N are electronic databases that are directly connected to server 100 and/or are connected to server 100 via a local network. Each of databases 150A-N includes machine-readable data storage capable of retrievably housing stored data, such as database or application data. In some examples, one or more of databases 150A-N includes long-term non-volatile storage media, such as magnetic hard discs, optical discs, flash memories and other forms of solid-state memory, or forms of electrically programmable memories (EPROM) or electrically erasable and programmable (EEPROM) memories. Databases 150A-N organize data using DBMSs 152A-N, respectively, and each of databases 150A-N can include a processor, at least one memory, and a user interface that are substantially similar to processor 102, memory 104, and user interface 106 of server 100. In at least some examples, one or more of databases 150A-N are relational databases. Each of databases 150A-N a structured database (e.g., a table or relational database) or a semi-structured database (e.g., a hierarchical and/or nested database). Databases 150A-N store data describing users who access server 100 and the software modules thereof (e.g., user 200).

Databases 150A-N can store, for example, descriptive user information, such as user purchase history information, user device hardware information, user device software information, user account status information, technical support service level information, and/or any other information useful for identifying relevant user information and/or information describing a user device for which technical support may be desired. In some examples, databases 150A-N can be databases of used by other servers and/or systems and can store additional data relevant to the task(s) performed by those servers and/or systems.

Each database 150A-N can associate the user identifier for each user of server 100 with one or more types of user information. Databases 150A-N can be configured to be queryable using user identifiers, such as user credentials (e.g., credentials for accessing server 100 functionality, such as a username or password), account numbers, and/or other suitable user descriptors to retrieve stored user information.

DBMS 152A-N are database management systems. As used herein, a “database management system” refers to a system of organizing data stored on a data storage medium. In some examples, a database management system described herein is configured to run operations on data stored on the data storage medium. The operations can be requested by a user and/or by another application, program, and/or software. The database management system can be implemented as one or more computer programs stored on at least one memory device and executed by at least one processor to organize and/or perform operations on stored data.

Vector database 160 is an electronic database that stores vector information representative of natural-language text. The vectors stored in vector database 160 are embedded as vectors using an embedding model/algorithm that transforms natural-language text into vectors representative of the text. The vectors can represent the words of the natural-language text (e.g., word vectors) and/or any other suitable element of the text. The natural-language text represented by the vectors of vector database 160 can be, for example, chat logs collected by chat module 110 and/or chat client 148. The vectors of vector database 160 can represent any suitable length of text, such as sentences, paragraphs, etc. In at least some examples, the vectors of vector database 160 represent sentences within messages and/or entire messages sent through the chat program(s) of chat module 110.

For example, the vectors of vector database 160 can represent technical support chat histories, including chat histories from both automated and human-mediated technical support. The vectors of vector database 160 can represent both user queries and responses generated by server 100. For example, chat module 110 and/or chat client 148 can collect and/or store a chat history of all messages sent within a particular time period, including all prompts sent by a user in chat client 148 as well as all responses generated by the programs of server 100 to those prompts. Server 100 and/or vector database 160 can separate the chat history into individual messages and/or sentences (i.e., in examples where a message includes more than one sentence), and store vector embeddings of those text segments in vector database 160.

Additionally and/or alternatively, vector database 160 can store vector embeddings of pre-generated (e.g., by a human operator) text usable to provide context to the program(s) of language generation module 130. For example, vector database 160 can store vector embeddings of forms or templates useful for generating responses relevant to technical support (e.g., a template outlining troubleshooting steps, etc.), user-performable instructions for resolving a technical support issue, and/or any other suitable pre-generated text that can be used by a machine-learning language model to generate responses useful for providing technical support and resolving technical support issues.

FIG. 1 depicts only one vector database 160 in system 10 for illustrative and explanatory clarity. In some examples, server 100 can include multiple vector databases store and organize vectors representative of different types of data, such that each vector database stores and organizes vectors representative of a single type of data, such as chat history data, template data, etc. In some of these examples, data retrieved from one of databases 150A-N can be used to select the vector database 160 queried by server 100 to generate a given natural language response and/or set of natural language responses.

To query vector database 160, server 100 and/or vector database 160 can generate a vector embedding of query text and compare that vector to the vectors stored to vector database 160. The vector embedding of the query text is referred to herein as a “query vector” and the vectors of the database are referred to herein as “database vectors.” The query vector can be generated using the same embedding algorithm and/or have the same number of dimensions as the database vectors (i.e., the vectors of vector database 160). Vectors stored to vector database 160 having a similarity score above a particular threshold and/or having the highest overall similarity to the query vector can be returned in response to the query. Vector similarity can be assessed by cosine similarity, cartesian similarity, and/or any other suitable test for assessing vector similarity. The corresponding raw data (i.e., the raw text information) represented by the returned vectors can then be retrieved and provided to server 100.

WAN 170 is a wide-area network suitable for connecting servers (e.g., server 100) and other computing devices that are separated by greater geographic distances than the devices of a local network, such as a local network connecting server 100 to user device 140 and/or databases 150A-N. WAN 170 includes network infrastructure for connecting devices separated by larger geographic distances. In at least some examples, WAN 170 is the Internet. Server 100 can communicate with remote database 180, remote database 182, and user device 140 via WAN 170.

Remote databases 180, 182 are remotely-located databases accessible by server 100 via WAN 170. Each of remote databases 180, 182 can be substantially similar to databases 150A-N and/or vector database 160. Remote database 180 is directly accessible (e.g., queryable) by server 100 and remote database 182 operates API 184. Server 100 can access data of database 180 by, for example, sending queries to remote database 180. Server 100 can access data of remote database 182 by sending API commands to API 184. API 184 can then query remote database 182 in response to API commands issued by server 100 and can provide data retrieved by remote database 182 in response to queries to server 100. API 184 can also perform additional database operations (i.e., operations other than retrieval) on the data of remote database 182) For explanatory clarity and simplicity, technical support system 10 is shown as only including two remote databases 180, 182. However, technical support system 10 can include any suitable number of remote, WAN-accessible databases. Further, for explanatory clarity and simplicity, the example of technical support system 10 shown in FIG. 1 only depicts remote database 182 as including an API for accessing database 182. However, technical support system 10 can include any number of remote databases that operate APIs for facilitating database access from server 100 and, in some examples, from other devices connected to WAN 170. API 184 can be any suitable API for performing database operations.

In some examples, databases 150A-N can be partitions of a single database and, in yet further examples, technical support system 10 can include only one database 150A-N. In yet further examples, one or both of remote databases 180, 182 can be a structured or semi-structured database performing the same functions as a database 150A-N, and technical support system 10 can lack or omit databases 150A-N. Further, in some examples, one or both of remote databases 180, 182 can at least partly operate as a vector database performing the same functions as vector database 160 and technical support system 10 can lack a locally-hosted vector database 160. Additionally and/or alternatively to any of the foregoing examples, technical support system 10 can lack or omit one or both of remote database 180 and remote database 182.

Chat module 110 is a software element of server 100 and includes one or more programs for operating a chat application in conjunction with chat client 148. The program(s) of chat module 110 receive user prompts from chat clients 148 and provide those user prompts to layered query module 120 and language generation module 130. Chat module 110 is also able to provide responses generated by language generation module 130 to chat client 148. Chat client 148 is an instance of a chat application instantiated on user device 140. In some examples, additional instances of the chat application can be instantiated on additional user devices connected to server 100 via WAN 170. Chat module 110 is also configured to receive and/or request user credentials from chat client 148 and to limit access to the functionality of server 100 to users having valid user credentials. The user credentials can be one or more of a username, a password, or any other identifier suitable for identifying a particular user of the chat functionality of server 100.

Chat client 148 is a software application that is able to provide user prompts to server 100 and to receive responses from server 100. Chat client 148 can be, in some examples, a web browser for accessing a web application hosted by server 100 that uses the functionality of chat module 110. In other examples, chat client 148 can be a specialized software application for interacting with chat module 110 of server 100. A user prompt submitted to server 100 through a chat client 148 is a natural-language text string including one or more user technical queries describing a technical issue the user is experiencing. The technical issue can relate to user device 140 and/or any other suitable electronic computing device. In some examples, chat client 148 can include some or all of the functionality of chat module 110 and server 100 can lack chat module 110, such that user device 140 is able to perform the functions of chat module 110. A user can provide user prompts by, for example, typing a natural-language phrase or sentence using a keyboard or a similar input device.

In some examples, chat client 148 can include a graphical user interface including one or more selectable graphical elements, such as one or more clickable elements and/or graphical buttons, representative of a natural-language text phrases that can be used as prompts for language generation module 130. A user can provide prompts to chat client 148 by interacting with the graphical elements of chat client 148 to select the natural-language text phrase(s) the user wants to use as an input to or prompt for language generation. Chat client 148 can then transmit the selected natural-language text phrase(s) to server 100 as the prompt for language generation by language generation module 130.

In some examples, chat client 148 can include a graphical user interface that displays a chat history between the user and server 100, such that a user can view previous user-submitted prompts and machine-generated replies created by server 100. Chat client 148 can display prior text replies as, for example, a conversation history or in any other suitable format. In some examples, client 148 can also display only the most-recent language generated by server 100.

Layered query module 120 is a software element of server 100 and includes one or more programs for performing layered queries of structured or semi-structured databases and vector databases. As will be explained in more detail subsequently, layered query module 120 is configured to retrieve user-specific information from a structured or semi-structured database (e.g., one of databases 150A-N) based on user identifier information. Layered query module 120 is further configured to retrieve text string information from a vector database (e.g., vector database 160) based on both a user query received by chat module 110 and the retrieved user-specific information. The sequential querying of structured/semi-structured databases and vector databases and the use of information retrieved from the structured/semi-structured database to formulate a query to a vector database is referred to herein as a “layered query” or a “layered database query.”

The program(s) of layered query module 120 can generate queries for databases 150A-N and vector database 160, and further can generate queries and communicate with remote database 180 and remote database 182. The program(s) of layered query module 120 can optionally be configured to generate API commands for API 184 in order to query remote database 182. Layered query module 120 is configured to generate database queries based on user identifier information and, further, based on user prompts supplied via a chat client (e.g., chat client 148). The user identifier information can be, for example, credentials used to access server 100 functionality and/or another identifier retrieved based on user credential information. Layered query module 120 can optionally be configured with a vector embedding algorithm for generating query vectors for vector database 160 or another suitable vector database based on natural-language text information and information retrieved from a structured or semi-structured database.

Language generation module 130 is a software element of server 100 and includes one or more programs for generating natural-language outputs based on natural language user prompts as well as information retrieved by the program(s) of layered query module 120. Language generation module 130 can use one or more trained, computer-implemented machine-learning models to generate natural-language responses to user prompts. The one or more trained, computer-implemented machine-learning models can be, for example, one or more language models, such as one or more large language models. The one or more language models and/or large language models can be, for example, one or more trained transformer models configured to generate natural-language outputs based on natural-language inputs. The language model(s) can be general-purpose natural-language model(s) and, in some examples, can be further trained and/or fine-tuned to generate language for technical support using a transfer learning or similar approach.

In operation, a user, such as user 200, provides a prompt to chat client 148 of user device 140 or another suitable instance of a chat client for interacting with chat service module 110 (including another instance on another device). The prompt is natural-language text and includes a technical support query describing, at least partially, a technical issue the user is experiencing. The chat client provides the user prompt to server 100. The chat client also provides a user identifier for the user to server 100. The user identifier can be, for example, access credentials for validating that the user is approved to access functionality of server 100, or any other suitable identifier for the user, such as the user's name, an account number for the user (e.g., a business account number), etc. In some instances, the user identifier can be provided within the natural language text of the prompt; in other instances, the user identifier can be provided by the user separately, or retrieved based on a source of the prompt, user permissions, or other contextual information.

The program(s) of layered query module 120 uses the user identifier received from the chat client to query a structured database or semi-structured database (e.g., one or more of databases 150A-N, one of remote databases 180, 182, etc.) to retrieve user-specific information for the user. The queried database stores information in a structure that is queryable with user identifiers and returns information useful to understanding the nature of the user's technical issue and steps that may be relevant to resolving that technical issue, such as the user's purchase history (including any electronic devices that have been purchased by the user), user device hardware information (e.g., for electronic devices the user is known to have and/or for which the user has a service contract), user device software information (e.g., for electronic devices the user is known to have and/or for which the user has a service contract), user account status (e.g., an account descriptor denoting a service level, such as a “gold level” or “platinum level” account), and/or a technical support service level (e.g., a level or value(s) defining a range of technical support services for which the user has contracted or otherwise should be provided). The returned information can also include other descriptive information, such as user biographical information (e.g., gender, preferred pronouns, age, etc.), user financial information, etc. For example, specific product information, hardware information, and/or software information may be useful for identifying one or more forms, templates, checklists, etc. stored to vector database 160 that can be used to improve outputs from a language model for resolving user technical issues. As a further example, if a user has a particular account status (e.g., a “gold level” or “platinum level” account), it can improve user experience for at least one message during the automated portion of the hybrid technical support session to acknowledge that account status. Further, there may be specific diagnostic and/or technical issue resolution tools that are only available to users having a particular contract or status (e.g., account level, support level, etc.).

In examples where server 100 is used to perform hybrid technical support having both automated and human-mediated technical support portions, vector database 160 can additionally and/or alternatively store vectors representative of natural-language text selected, configured, written, arranged, etc. to elicit additional information from a user that is useful for solving the technical problem for which support is sought by the user. Advantageously, in these examples, automated technical support can be used initially to elicit additional diagnostic information from a user. The additional diagnostic information can be, for example, whether a recommended or likely solution to possible technical problems was successful in resolving the user's technical issue. The hybrid technical support session can then shift or transition to a human-mediated technical support session and the human support technician can use the additional elicited diagnostic information in addition to the user's initial query to improve support quality and decrease the support technician time required to diagnose and/or resolve the user's technical issue.

The program(s) of layered query module 120 can combine the retrieved information with the user's natural-language prompt to form an augmented prompt. The program(s) of layered query module 120 can create a vector embedding of the augmented prompt and/or the program(s) of layered query module 120 can provide the augmented prompt to vector database 160 and one or more program(s) of vector database can create a vector embedding of the augmented prompt. The vector embedding can then be used to query vector database and similar database vectors of vector database 160 can be identified in response to the query. Vector database 160 can retrieve the natural-language text represented by the identified vectors and provide that natural-language text to server 100.

In some examples, the database vectors of vector database 160 can include embedding dimensions that correspond to the types of data retrievable from the structured or semi-structured databases and/or elements specific to that retrievable data, such that vector retrieval by vector database 160 is able to use similarity in those vector embedding dimensions of the query vector and database vectors to narrow the search space of vector database 160, advantageously reducing the computational cost associated with searching vector database 160. Additionally and/or alternatively, the vectors of vector database 160 can represent user-specific information in embedding dimensions that are not specific to or exclusively representative of user-specific information. Advantageously, this can provide additional information to accurately identify user-relevant natural-language text information for context injection when searching vector database 160.

The program(s) of layered query module 120 provide the original user prompt, the information retrieved from the structured or semi-structured database, and the information retrieved from vector database 160 to language generation module 130. The computer-implemented machine-learning model(s) of language generation module 130 generate a natural-language response to the user prompt using the user prompt, the information retrieved from the structured or semi-structured database, and the information retrieved from vector database 160 to language generation module 130. The natural-language generated by language generation module 130 is responsive to the user's technical issue. The manner in which the natural-language generated by language generation module 130 is response to the user's technical issue is determined, at least in part, on the natural-language retrieved from vector database 160. In some examples, the natural-language generated by language generation module 130 includes one or more instructions for resolving the user's technical issue that are based, at least in part, on the natural-language retrieved from vector database 160. Advantageously, the use of the retrieved information from the structured or semi-structured database and vector database 160 provides additional context to the trained, computer-implemented machine-learning model and improves the accuracy of the natural-language response generated thereby, reducing the occurrence of AI hallucinations or fabrications that can occur during natural-language text generation and, further, increasing the likelihood that language generated by language generation module 130 relates to the user's technical issue or query.

In some examples, the program(s) of layered query module 120 can query multiple structured and semi-structured databases using the user identifier and can use retrieved information from multiple databases to create the augmented prompt used to query vector database 160. For example, user-specific information useful for identifying, diagnosing, and/or resolving user technical issues may be stored in multiple databases (e.g., purchase history information stored to a first database, product hardware and/or software information stored to a second database, etc.). Additionally and/or alternatively, the program(s) of layered query module 120 can query multiple structured or semi-structured databases with the user identifier and use only a subset of the retrieved information to query vector database 160. In these examples, the additional retrieved information can be provided to language generation module 130 as context for response generation. Further, in some examples, the information retrieved from the structured or semi-structured database (i.e., the information retrieved based on the user identifier) is used to query vector database 160 and only the information retrieved from vector database 160 and the original user prompt can be provided to language generation module 130, such that the initial retrieved information is not used to generate a natural-language response.

In some examples, vector database 160 can be partitioned such that different partitions of vector database 160 store vector embeddings of text specific to particular user identifiers (e.g., to particular users, to particular items purchasable by users, etc.). Layered query module 120 can use the user identifier(s) for a user to identify one or more relevant partitions of vector database and query those partitions with a query vector representative of the user prompt and/or both the user prompt and the user identifier(s).

Automated technical support aided by the layered query approach outlined herein provides numerous advantages. The layered query approach outlined herein increases the likelihood that the information retrieved from vector database 160 is relevant to a user's technical problem. More specifically, the layered query approach allows terms both from the user's own description of the user technical issue as well as terms derived from the user's known attributes to be used to search vector database 160, increasing the likelihood that retrieved natural-language information is relevant to the user's technical issue and, consequently, also increasing the likelihood that natural-language generated by language generation module 130 is useful to resolving the user's technical issue. As such, the layered query approach outlined herein reduces the likelihood that an inaccurate user-provided description of the user's technical issue, of the affected device, etc. causes server 100 to generate a natural-language technical support response that is irrelevant to and/or unable to diagnose, resolve, etc. the user's actual technical issue. If a user misstates or improperly describes the user's technical issue and/or one or more relevant features of the affected electronic device (due to, e.g., lack of technical expertise), the information retrieved based on the user's identifier (e.g., from one of databases 150A-N) increases the likelihood that the vector search of vector database 160 returns natural-language that accurately describes, relates to, diagnoses, resolves, etc. the user's technical issue. Accordingly, the information retrieved based on the user's identifier (e.g., from one of databases 150A-N) increases the likelihood that natural-language text generated by server 100 is relevant to the user's actual technical issue, including in examples where the user is unable to accurately describe, diagnose, and/or understand the technical issue the user is experiencing, relevant aspects of the affected device, etc. Further, by increasing the accuracy automated technical support aided by the layered query approach outlined herein improves user experience with automated technical support by increasing the likelihood that automated responses generated by server 100 can be used to resolve the user technical issue.

The layered database query approach outlined herein also has several advantages over conventional database retrieval approaches for context injection, such existing retrieval-augmented generation (RAG) methods. Layered query module 120 enables user-specific information to be used to query a vector database prior to natural-language text generation by language generation module 130. The user-specific vector database queries described herein increase the likelihood that text information retrieved from a vector database query is relevant to a particular user and, in turn, reduces the likelihood that irrelevant or extraneous information is retrieved. Advantageously, reducing the overall quantity of text provided to a language model (or other computer-implemented machine-learning model configured to generate natural-language) as context (e.g., via RAG or a RAG-like approach) can reduce the computational cost associated with generating response text and, accordingly, can reduce the overall time required to generate the response text. Further, the user-specific queries performed by layered query module 120 are able to create context-augmented prompts for language generation that reduce computational cost while provided similar or superior hallucination/fabrication reduction as existing context injection techniques that use conventional vector database retrieval. Reducing time required to generate response text can also advantageously reduce lag perceived by users between prompt submission (i.e., via chat client 148) and response receipt (i.e., of a natural-language response generated by language generation module 130).

Further, in examples where inputs to the language model are token-limited (i.e., where prompt or input text is limited to a particular size, or where increased computational costs associated with larger prompts increase corresponding fees), the layered queries layered query module 120 can significantly increase the accuracy of a response generated from a particular, fixed number of tokens.

Additionally, the layered query approach outlined herein can be used to reduce computational costs associated with vector database queries used for content injection. More specifically, the user-specific information retrieved from a structured or semi-structured database increases the likelihood that vectors retrieved from a vector database are representative of user-relevant information, allowing accurate database retrieval to be performed using query and database vectors having a relatively low or otherwise decreased number of vector dimensions. Advantageously, reducing the number of vector dimensions compared during a vector database query reduces computational cost associated with querying the vector database. Reducing the computational cost associated with querying the vector database further reduces the time required by server 100 to process and provide responses to user prompts, providing further improvements to the lag perceived by users between prompt submission and response receipt.

While the layered query approach described herein has been generally described with respect to sequential queries of a structured or semi-structured database and a vector database, in some examples the layered query approach described herein can be used to sequentially query two structured or semi-structured databases. For example, a first structured or semi-structured database can be queried using a user identifier and a second structured or semi-structured database can be queried using information retrieved from the first database and, in some examples, one or more words extracted from the user's prompt. For example, a natural-language processing algorithm or another suitable algorithm can be used to extract an intent of the user's prompt or query, and the information retrieved from the first database and/or the extracted intent can be used to query the second database. The user's original prompt can then be augmented with the information retrieved from the second database and, in some examples, the information retrieved from the first database (as described previously) before the augmented prompt is submitted for language generation.

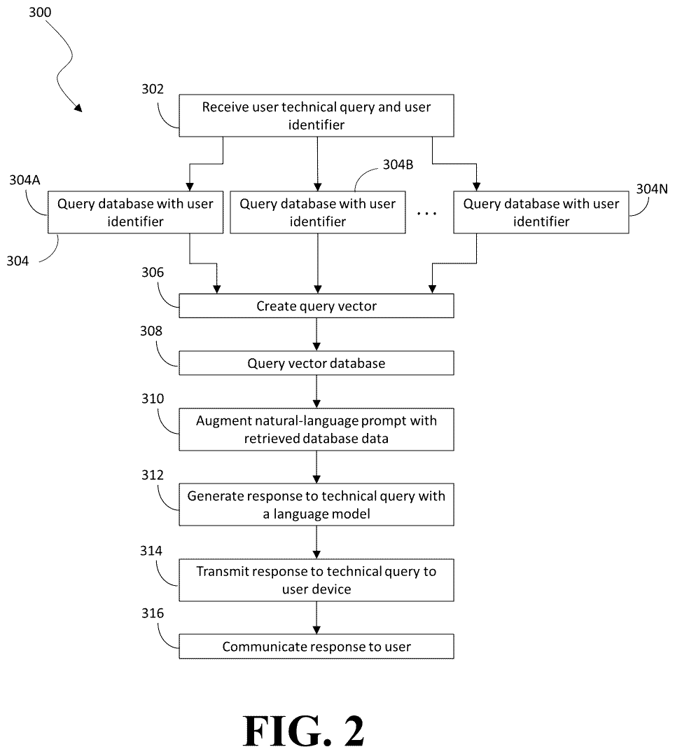

FIG. 2 is a flow diagram of method 300, which is a method of performing automated technical support using layered queries for context injection. Method 200 is performable by technical support system 10 (FIG. 1). Method 300 includes steps 302-316 of receiving a prompt and a user identifier (step 302), querying a database with the user identifier (steps 304A-N), creating a query vector (step 306), querying a vector database (step 308), augmenting a natural-language query with retrieved database data (step 310), generating a natural-language response with a language model (step 312), transmitting the natural-language response to a user device (step 314), and displaying the natural-language response to the user (step 316). Method 300 performable by server 100 of technical support system 10 and is described herein with reference to technical support system 10 (FIG. 1), but method 300 can be implemented in any suitable system to enable layered database query-based context injection. Advantageously, method 300 improves the likelihood that natural-language text generated for automated technical support relates to the user's technical issue and is able to accurately diagnose and/or resolve the user's technical issue or query. Method 300 also significantly computational costs associated with context injection (e.g., RAG), thereby also reducing time required to generate context-enhanced natural-language responses using a language model.

In step 302, server 100 receives a technical support prompt and a user identifier from a user device, such as local device 140. A user can enter a prompt into a chat client configured to interact with and use functionality of server 100 (e.g., chat client 148). The prompt includes one or more technical queries related to a technical issue the user is experiences with one or more electronic devices. The affected device(s) can be the device operating the chat client and/or any other suitable electronic device. For example, if the technical issue relates to an improperly functioning or non-functioning electronic device, the user may operate chat client from a different device than the affected device. The chat client can provide the prompt and an identifier for the user to server 100.

The prompt is natural-language text (e.g., a text string) that includes a natural-language representation of one or more user queries related to the user's technical issue. The user identifier can be, for example, an account name, an access credential (e.g., a username), an account number, the user's personal name (e.g., a first and/or last name), etc. In some examples, a user can submit access credentials (e.g., a username, password, etc.) to the chat client and the chat client can verify that the user is approved to access server 100 functionality by validating the provided credentials with credentials stored to server 100. The chat client can store or retain an identifier for the user and can provide that identifier as the user identifier with prompts submitted by the user to server 100.

After step 302, method 300 proceeds to one or more of steps 304A-N. Steps 304A-N are collectively referred to herein as “steps 304” and steps 340A-N are individually referred to herein as a “step 304.” In each of steps 304, server 100 queries a structured or semi-structured database to retrieve user-specific information descriptive of the user and/or one or more electronic devices owned and/or possessed by the user. For example, the information retrieved in step 304 can be the user's purchase history (including any electronic devices that have been purchased by the user), user device hardware information (e.g., for electronic devices the user is known to have and/or for which the user has a service contract), user device software information (e.g., for electronic devices the user is known to have and/or for which the user has a service contract), user account status (e.g., an account descriptor denoting a service level, such as a “gold level” or “platinum level” account), and/or a technical support service level (e.g., a level or value(s) defining a range of technical support services for which the user has contracted or otherwise should be provided). The returned information can also include other descriptive information, such as user biographical information (e.g., gender, preferred pronouns, age, etc.), user financial information, etc.

While FIG. 2 shows three steps 304 (i.e., steps 304A, 304B, 304N), method 300 can include any number steps 304. In some examples, method 300 can include only a single step 304, such that server 100 only queries a single database with the user identifier. The number of steps 304 included in method 300 can be selected according to the number of database queries desired to be performed.

In step 306, a query vector is created using the user prompt received in step 302 and database information retrieved in step(s) 304. Creation of a query vector can be performed by either server 100 or the vector database. Server 100 can create the query vector by creating a vector embedding representative of the user prompt and one or more information elements retrieved in step(s) 304. Some or all of the information retrieved in step 304 can be used to create the query vector in step 306. In some examples, server 100 can use a natural-language processing algorithm or another suitable algorithm or machine learning model to extract the user's technical query from the user prompt, thereby removing one or more filler words, extraneous text segments, etc. from the user's prompt. In these examples, server 100 can create the query vector by creating a vector embedding of the extracted user technical query as well as one or more elements of information retrieved in step 304.

Server 100 can then query the vector database with the query vector. Additionally and/or alternatively, server 100 can provide the user prompt and at least some of the information retrieved in step(s) 304 to the vector database, and the vector database can create a vector embedding of the prompt and the provided database information.

In some examples, it may be advantageous to retrieve more information from databases in step(s) 304 than is provided in step 306. For example, if the information represented in the database vectors is not related to some of the information retrieved in step(s) 304, including that information in the query vector can decrease the relevancy of information returned from a vector database query using the query vector. For example, user biographical information may not be relevant to queries of vector database 160, but may nonetheless be relevant to language generation in subsequent steps of method 300 (e.g., by providing the user's preferred pronouns as context for language generation module 130). However, in yet other examples, it can be advantageous to represent all information retrieved in step(s) 304 in query vector. In all examples, the query vector is an embedding of the user prompt and at least some of the information retrieved in step(s) 304.

In step 308, server 100 queries the vector database with the query vector created in step 306. Querying the vector database in step 308 identifies one or more database vectors having a sufficient similarity to the query vector. The vector database can use any suitable similarity test and any suitable similarity threshold for identifying similar vectors. The similarity test can be, for example, a cosine similarity test, a cartesian similarity test, etc. The vector database can then retrieve the natural-language text strings represented by the identified vector embeddings and provide those text strings to server 100 for further use with method 300. Querying vector database 160 (Step 308) retrieves non-vectorized (e.g., natural language) text corresponding to database vectors satisfying vector similarity criteria with query vectors, as discussed above.

The vector database queried in step 308 can store vector representations of any relevant natural-language text information. For example, the vector database can store forms or templates useful for generating responses relevant to technical support (e.g., a template outlining troubleshooting steps, etc.), user-performable instructions for resolving a technical support issue, and/or any other suitable pre-generated text that can be used by a machine-learning language model during subsequent step 312 to generate responses useful for providing technical support and resolving technical support issues. In yet further examples, the vector database can store vector representations of technical support chat history. The chat history can include, for example, one or more messages sent by the user (e.g., as prompts) as well as messages returned by server 100 and/or a human technical support technician as responses to the technical queries contained within those messages. The chat histories stored by the vector database and retrieved in step 308 can be specific to the user who submitted the prompt in step 302 and/or other users who were provided with technical support by server 100 and/or by one or more human support technicians.

Notably, chat history from the user and/or other users facing similar technical issues can include successful instructions for resolving those technical issues as well as natural-language confirmation from a user of technical issue resolution. In some examples, the use of chat history information by a machine-learning language model in subsequent step 312 increases the likelihood that the natural-language response generated therefrom is able to solve the user's technical issue, as chat history information can include natural-language responses from a user describing the effectiveness of the instructions provided by server 100 (e.g., in automated technical support) and/or a human support technician (e.g., in human-mediated technical support). Further, querying a database storing vector embeddings of a technical support chat history can allow for select portions of technical support chat history to be used to provide context during response generation (i.e., during subsequent step 312), reducing computational costs as compared to examples where a user's entire technical support chat history is used as context for each prompt submitted by a user.

In step 310, server 100 augments the natural-language prompt with data retrieved in step(s) 304 and the data retrieved in step 306. Server 100 can augment the natural-language prompt by adding natural-language representations of the information retrieved in step(s) 304 as well as the natural-language text string(s) retrieved in step 308 to the user prompt received in step 302.

In step 312, server 100 generates a natural-language response with a language model based on the augmented natural-language prompt generated in step 310. Server 100 provides the augmented natural-language prompt to a trained, computer-implemented machine-learning model configured to generate a natural-language text response based on a natural-language text prompt. The trained, computer-implemented machine-learning model can be referred to in some examples as a language model. In some examples the trained, computer-implemented machine-learning model can be a large language model and/or a transformer model. The natural-language generated in step 312 is responsive to the to the user's technical issue and the manner in which the natural-language responds to the user's technical issue is determined, at least in part, on the natural-language retrieved from a vector database in step 308. In some examples, the natural-language generated in step 312 includes one or more instructions. The instructions can be based, at least in part, on the natural-language retrieved from the vector database in step 308.

In step 314, server 100 transmits the natural-language response text generated in step 312 to the user device. The chat client of the user device can represent an indication of the natural-language response text as a response to the user's prompt (i.e., the prompt received in step 302).

In step 316, the user device displays the natural-language response text to the user. Step 316 is optional and is performed where the chat client provides the initiation of the natural-language response by displaying, e.g., on a display device the natural-language text response. For example, user device 140 can display the natural-language response text using user interface 146. The chat client operated by the user device can cause the user device to display the response text (e.g., by causing a processor of the device to execute one or more instructions that causes the user device to display the natural-language response text).

The user can then review the response text and perform any instructions contained therein to resolve the user's technical issues. Method 300 can be performed in whole or in part for each subsequent prompt submitted by the user to generate new natural-language responses for diagnosing, resolving, etc. the user's technical issue. Method 300 can, for example, omit steps 304A-N in subsequent iterations where it is not necessary to retrieve new user-specific information for querying the vector database in step 308. Subsequent iterations of method 300 can use all, part, or none of the user's prior messages to the technical support service to query the vector database in step 308 and, further, can use all, part, or none of the user's prior messages to the technical support service to create the augmented natural-language prompt in subsequent iterations of step 310. Using part or all of prior messages from the user in steps 306 and 308 can improve the accuracy of the automated technical support generated using method 300.

Method 300 advantageously uses a layered query approach to perform context injection (e.g., RAG) to enhance language model prompts and reduce the occurrence of hallucinations or fabrications in language model outputs. Method 300 provides the same advantages as described previously with respect to server 100 and layered query module 120 (FIG. 1). Notably, method 300 improves the likelihood that automated technical support responses adequately respond to user technical inquiries and/or are able to resolve those technical inquiries by incorporating user-specific information into vector database queries to retrieve form, template, checklist, etc. information for language generation. Improving automated response quality can advantageously provide concomitant improvements to user experience with automated or partially-automated technical support. In examples where the automated technical support is an initial portion or phase of a hybrid technical support scheme and where vector database 160 can be queried to retrieve natural-language for eliciting additional diagnostic information, method 300 can also be used to reduce human support technician time required to diagnose and/or resolve user technical issues.

Further, method 300 reduces computational cost associated with context injection approaches to hallucination and/or fabrication reduction (e.g., RAG) by using user-specific information (i.e., information retrieved in step(s) 304) to improve the relevance of information retrieved from a vector database (i.e., in step 308). As such, method 300 can be used to decrease the quantity of information (i.e., the quantity of text) provided to a language model for response generation by improving the likelihood that information used for context is user-relevant. Reducing the size of an input to a language model can decrease the computational load required to generate an output and, further, can thereby reduce the time required to produce the output. In examples where inputs to a language model are token-limited, method 300 can improve the likelihood that information included as context is relevant to a user's prompt. Further, as discussed previously with respect to server 100 and layered query module 120 (FIG. 1), method 300 can also be used to decrease computational cost associated with vector database queries.

While method 300 is discussed generally herein with reference to automated technical support, in other examples, method 300 can be used in a hybrid technical support scheme having automated and human-mediated portions. Method 300 can provide the advantages described herein to the automated portion of a hybrid technical support scheme. Following the automated portion performed according to method 300, a human support technician can be connected to the user via server 100 to perform the human-mediated portion of the hybrid technical support. The human support technician can communicate with the user using, for example, a suitable computing device operating a chat client for sending messages to and receiving messages from server 100, such that chat module 110 is able to relay message between the user and the assigned support technician. The support technician device can include a processor, memory, and user interface that are substantially similar to processor 142, memory 144, and user interface 146, and can be directly-connected to server 100, locally-connected to server 100 (i.e., via a local area network), and/or connected to server 100 via WAN 170.

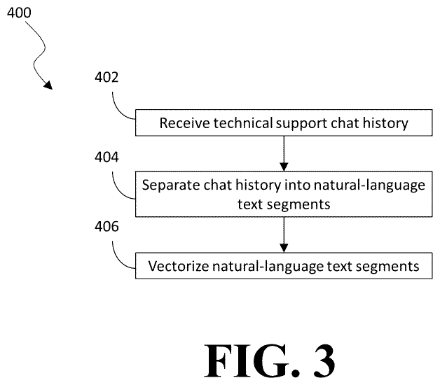

FIG. 3 provides a flowchart of method 400, a method of creating database vectors representing a user's chat history. Method 400 can be used to, for example, generate database vectors for the database queried in step 308 of method 300 (FIG. 2), such as vector database 160 (FIG. 1). Method 400 includes steps 402-406 of receiving a user's chat history (step 402), separating the chat history into natural-language text segments (step 404), and vectorizing those natural-language text segments (step 406). Method 400 will be described herein with general reference to technical support system 10 for explanatory purposes, however, method 400 can be performed by any suitable computing device.

In step 402, server 100 receives a user's chat history. Server 100 can store a user's chat history to, for example, memory 104 and server 100 can retrieve the user's chat history from memory 104 in step 402. Additionally and/or alternatively, the chat client used by the user can store the user's chat history, and server 100 can request the user's chat history from the user's chat client. The chat history includes all prompts submitted to by the user and/or all responses generated by server 100 in response to the chat history.

In step 404, server 100 separates the chat history into natural-language text segments. The segments can be sentences, paragraphs, individual messages (i.e., prompts and/or responses), and/or any other suitable size of text. The text segments are of a size (i.e., character length) that is suitable for vectorization in step 406.

In step 406, server 100 vectorizes the natural-language text segments generated in step 404. Server 100 can create vector embeddings of the natural-language text segments using any suitable embedding algorithm and having a number of dimensions. Server 100 can then store the text segments to a vector database, such as vector database 160.

Method 400 can be performed for any number of users of a technical support chat service and can store chat histories derived from any type of technical support. Method 400 can be used to store vectors representative of chat histories from automated technical support, human-mediated technical support, and/or technical support having both automated and human-mediated portions.

### Discussion of Possible Embodiments

The following are non-exclusive descriptions of possible embodiments of the present invention.

A method of automated technical support, the method comprising: receiving, by a processor of a network-connected device, a first natural-language prompt from a user and a user identifier corresponding to the user, the first natural-language prompt including at least one technical support query; querying, by the processor, a first database with the user identifier to retrieve first information; generating, by the processor, a first vector embedding representative of the first information and the first natural-language prompt; querying, by the processor, a second database using the first vector embedding to retrieve second information, wherein: the second database is a vector database comprising a plurality of vectors, each vector of the plurality of vectors representative of a text segment of a plurality of text segments, and the second information comprises at least one text segment of the plurality of text segments; and generating, by a language model executed by the processor, a first natural-language response text based on the first natural-language prompt, the first information, and the second information, the first natural-language response text responsive to the at least one technical support query.

The method of the preceding paragraph can optionally include, additionally and/or alternatively, any one or more of the following features, configurations and/or additional components:

A further embodiment of the foregoing method, wherein the first natural-language response text includes at least one instruction for resolving the at least one technical support query.

A further embodiment of the foregoing method, wherein the first information is at least one of a user purchase history, user device hardware information, user device software information, a technical support service level, and a prior technical support chat history.

A further embodiment of the foregoing method, wherein the second information is at least one of a technical support template, user-performable instructions for resolving the at least one technical support query, one or more previous user prompts, one or more previously-generated natural-language responses, one or more chat sessions including a technical support agent.

A further embodiment of the foregoing method, and further comprising querying, by the processor, a third database with the user identifier to retrieve third information, and wherein generating, by the processor, the first vector embedding comprises a generating a first vector embedding representative of the first information, the third information, and the first natural-language prompt.

A further embodiment of the foregoing method, wherein the third information is at least another one of at least one of the user purchase history, the user device hardware information, the user device software information, the technical support service level, and the prior technical support chat history.

A further embodiment of the foregoing method, wherein receiving, by the processor, the first natural-language prompt and the user identifier comprises: receiving, by a chat client operated by a user device in electronic communication with the network-connected device, a natural-language text input from the user including the first natural-language prompt; generating, by the user device, a request comprising the first natural-language prompt and the user identifier; providing, by the user device, the request to the network-connected device; and extracting, by the processor, the user identifier and the first natural-language prompt from the request.

A further embodiment of the foregoing method, wherein providing the request to the network-connected device comprises transmitting the request to the network-connected device via a communication network connecting the network-connected device and the user device.

A further embodiment of the foregoing method, and further comprising: transmitting, by the server, the first natural-language response text to the user device; and providing, by the chat client, a first electronic indication of the first natural-language response text to the user.

A further embodiment of the foregoing method, and further comprising: receiving, by the processor and after providing the first electronic indication to the user, a second natural-language prompt from the user, the second natural-language prompt including at least one technical support query; generating, by the processor, a second vector embedding representative of the first information and the second natural-language prompt; querying, by the processor, the second database using the second vector embedding to retrieve third information, wherein the third information comprises a different at least one text segment of the plurality of text segments; and generating, by a language model executed by the processor, a second natural-language response text based on the second natural-language prompt, the first information, and the third information, the second natural-language response text responsive to the at least one technical support query.

A further embodiment of the foregoing method, wherein the first database is at least one of a structured database and a semi-structured database.

A further embodiment of the foregoing method, and further comprising: receiving a chat history for the user, the chat user comprising a plurality of historical natural-language queries provided by the user and a plurality of historical first natural-language response texts created by the language model; separating the plurality of natural-language queries and the plurality of historical first natural-language response texts into a plurality of natural language text segments; vectorizing the plurality of natural language text segments to create the plurality of vectors.

A further embodiment of the foregoing method, wherein generating the first natural-language response text comprises: generating an augmented first natural-language prompt by combining text information from the first natural-language prompt, the first information, and the second information; generating, by the language model, the first natural-language response text based on the augmented first natural-language prompt.

A further embodiment of the foregoing method, wherein querying the first database comprises: transmitting, by the network-connected device, a query request for the first database to a database server, wherein: the database server comprises the first database, and the request includes an application programming interface command for an application programming interface operated by the database server to query the first database; executing, by the application programming interface, the application programming interface command to query the first database to retrieve the first information; transmitting, by the database server, the retrieved first information to the network-connected device.

A further embodiment of the foregoing method, wherein: the vector database comprises a plurality of partitions of vector data; querying the second database using the first vector embedding comprises: selecting a partition of vector data of the plurality of partitions of vector data based on the user identifier; and comparing the first vector embedding to vectors of the partition of vector data to retrieve the second information.

A system comprising: a first database configured to store first user-specific information; a second database configured to store a plurality of vector embeddings representative of a plurality of natural-language text segments, each first vector embedding of the plurality of vector embeddings representative of one natural-language text segment of the plurality of natural-language text segments; a network-connected device in electronic communication with the first database and with the second database, the network-connected device comprising: a processor; and at least one memory encoded with instructions that, when executed, cause the processor to: receive a first natural-language prompt from a user and a user identifier corresponding to the user, the first natural-language prompt including at least one technical support query; query the first database with the user identifier to retrieve first information; generate a first vector embedding representative of the first information and the first natural-language prompt; query the second database using the first vector embedding to retrieve second information; and generate, using a language model executed by the processor, a first natural-language response text based on the first natural-language prompt, the first information, and the second information, the first natural-language response text responsive to the at least one technical support query.

The system of the preceding paragraph can optionally include, additionally and/or alternatively, any one or more of the following features, configurations and/or additional components:

A further embodiment of the foregoing system, wherein the first natural-language response text includes at least one instruction for resolving the at least one technical support query.

A further embodiment of the foregoing system, wherein the first information is at least one of a user purchase history, user device hardware information, user device software information, a technical support service level, and a prior technical support chat history.

A further embodiment of the foregoing system, wherein the second information is at least one of a technical support template, user-performable instructions for resolving the at least one technical support query, one or more previous user prompts, one or more previously-generated natural-language responses, one or more chat sessions including a technical support agent.

A further embodiment of the foregoing system, wherein the system further comprises a user device in electronic communication with the network-connected device, and the instructions, when executed, further cause the processor to transmit, to the user device, an electronic indication of the first natural-language response text to the user device.

A method of automated technical support, the method comprising: receiving, by a processor of a network-connected device, a first natural-language prompt from a user and a user identifier corresponding to the user, the first natural-language prompt including at least one technical support query; querying, by the processor, a first database with the user identifier to retrieve first information; generating, by the processor, a representation of the first information and the first natural-language prompt; querying, by the processor, a second database using the first representation to retrieve second information; generating, by a language model executed by the processor, a first natural-language response text based on the first natural-language prompt, the first information, and the second information, the first natural-language response text responsive to the at least one technical support query.

### Summation

Any relative terms or terms of degree used herein, such as “substantially”, “essentially”, “generally”, “approximately” and the like, should be interpreted in accordance with and subject to any applicable definitions or limits expressly stated herein. In all instances, any relative terms or terms of degree used herein should be interpreted to broadly encompass any relevant disclosed embodiments as well as such ranges or variations as would be understood by a person of ordinary skill in the art in view of the entirety of the present disclosure, such as to encompass ordinary manufacturing tolerance variations, incidental alignment variations, alignment or shape variations induced by thermal, rotational or vibrational operational conditions, and the like.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of automated technical support, the method comprising:
receiving, by a processor of a network-connected device, a first natural-language prompt from a user and a user identifier corresponding to the user, the first natural-language prompt including at least one technical support query;
querying, by the processor, a first database with the user identifier to retrieve first information;
generating, by the processor, a first vector embedding representative of the first information and the first natural-language prompt;
querying, by the processor, a second database using the first vector embedding to retrieve second information, wherein:
the second database is a vector database comprising a plurality of vectors,
each vector of the plurality of vectors representative of a text segment of a plurality of text segments, and
the second information comprises at least one text segment of the plurality of text segments; and
generating, by a language model executed by the processor, a first natural-language response text based on the first natural-language prompt, the first information, and the second information, the first natural-language response text responsive to the at least one technical support query.

2. The method of claim 1, wherein the first natural-language response text includes at least one instruction for resolving the at least one technical support query.

3. The method of claim 2, wherein the first information is at least one of a user purchase history, user device hardware information, user device software information, a technical support service level, and a prior technical support chat history.

4. The method of claim 3, wherein the second information is at least one of a technical support template, user-performable instructions for resolving the at least one technical support query, one or more previous user prompts, one or more previously-generated natural-language responses, one or more chat sessions including a technical support agent.

5. The method of claim 4, and further comprising querying, by the processor, a third database with the user identifier to retrieve third information, and wherein generating, by the processor, the first vector embedding comprises a generating a first vector embedding representative of the first information, the third information, and the first natural-language prompt.

6. The method of claim 5, wherein the third information is at least another one of at least one of the user purchase history, the user device hardware information, the user device software information, the technical support service level, and the prior technical support chat history.

7. The method of claim 6, wherein receiving, by the processor, the first natural-language prompt and the user identifier comprises:
receiving, by a chat client operated by a user device in electronic communication with the network-connected device, a natural-language text input from the user including the first natural-language prompt;
generating, by the user device, a request comprising the first natural-language prompt and the user identifier;
providing, by the user device, the request to the network-connected device; and
extracting, by the processor, the user identifier and the first natural-language prompt from the request.

8. The method of claim 7, wherein providing the request to the network-connected device comprises transmitting the request to the network-connected device via a communication network connecting the network-connected device and the user device.

9. The method of claim 7, and further comprising:
transmitting, by the server, the first natural-language response text to the user device; and
providing, by the chat client, a first electronic indication of the first natural- language response text to the user.

10. The method of claim 9, and further comprising:
receiving, by the processor and after providing the first electronic indication to the user, a second natural-language prompt from the user, the second natural-language prompt including at least one technical support query;
generating, by the processor, a second vector embedding representative of the first information and the second natural-language prompt;
querying, by the processor, the second database using the second vector embedding to retrieve third information, wherein the third information comprises a different at least one text segment of the plurality of text segments; and
generating, by a language model executed by the processor, a second natural-language response text based on the second natural-language prompt, the first information, and the third information, the second natural-language response text responsive to the at least one technical support query.

11. The method of claim 1, wherein the first database is at least one of a structured database and a semi-structured database.

12. The method of claim 1, and further comprising:
receiving a chat history for the user, the chat user comprising a plurality of historical natural-language queries provided by the user and a plurality of historical first natural-language response texts created by the language model;
separating the plurality of natural-language queries and the plurality of historical first natural-language response texts into a plurality of natural language text segments; and
vectorizing the plurality of natural language text segments to create the plurality of vectors.

13. The method of claim 1, wherein generating the first natural-language response text comprises:
generating an augmented first natural-language prompt by combining text information from the first natural-language prompt, the first information, and the second information; and
generating, by the language model, the first natural-language response text based on the augmented first natural-language prompt.

14. The method of claim 1, wherein querying the first database comprises:
transmitting, by the network-connected device, a query request for the first database to a database server, wherein:
the database server comprises the first database, and
the request includes an application programming interface command for an application programming interface operated by the database server to query the first database;
executing, by the application programming interface, the application programming interface command to query the first database to retrieve the first information; and
transmitting, by the database server, the retrieved first information to the network- connected device.

15. The method of claim 1, wherein:
the vector database comprises a plurality of partitions of vector data;
querying the second database using the first vector embedding comprises:
selecting a partition of vector data of the plurality of partitions of vector data based on the user identifier; and
comparing the first vector embedding to vectors of the partition of vector data to retrieve the second information.

16. A system comprising:
a first database configured to store first user-specific information;
a second database configured to store a plurality of vector embeddings representative of a plurality of natural-language text segments, each first vector embedding of the plurality of vector embeddings representative of one natural-language text segment of the plurality of natural-language text segments;
a network-connected device in electronic communication with the first database and with the second database, the network-connected device comprising:
a processor; and
at least one memory encoded with instructions that, when executed, cause the processor to:
receive a first natural-language prompt from a user and a user identifier corresponding to the user, the first natural-language prompt including at least one technical support query;
query the first database with the user identifier to retrieve first information;
generate a first vector embedding representative of the first information and the first natural-language prompt;
query the second database using the first vector embedding to retrieve second information; and
generate, using a language model executed by the processor, a first natural-language response text based on the first natural-language prompt, the first information, and the second information, the first natural-language response text responsive to the at least one technical support query.

17. The system of claim 16, wherein the first natural-language response text includes at least one instruction for resolving the at least one technical support query.

18. The system of claim 17, wherein:
the first information is at least one of a user purchase history, user device hardware information, user device software information, a technical support service level, and a prior technical support chat history; and
the second information is at least one of a technical support template, user-performable instructions for resolving the at least one technical support query, one or more previous user prompts, one or more previously-generated natural-language responses, one or more chat sessions including a technical support agent.

19. The system of claim 18, wherein the system further comprises a user device in electronic communication with the network-connected device, and the instructions, when executed, further cause the processor to transmit, to the user device, an electronic indication of the first natural-language response text to the user device.

20. A method of automated technical support, the method comprising:
receiving, by a processor of a network-connected device, a first natural-language prompt from a user and a user identifier corresponding to the user, the first natural-language prompt including at least one technical support query;
querying, by the processor, a first database with the user identifier to retrieve first information;
generating, by the processor, a representation of the first information and the first natural-language prompt;
querying, by the processor, a second database using the first representation to retrieve second information;
generating, by a language model executed by the processor, a first natural-language response text based on the first natural-language prompt, the first information, and the second information, the first natural-language response text responsive to the at least one technical support query.
